(19) United States
(12) Patent Application Publication
(10) Pub. No.: US 2007/0017396 A1
(43) Pub. Date: Jan. 25, 2007

(54) Dual heating system for high speed printing

(75) Inventors: Thomas A. Liguori, Poway, CA (US); Kirby W. Bates, Normandy, TN (US)

Correspondence Address: FULBRIGHT AND JAWORSKI LLP, 555 S. FLOWER STREET, 41ST FLOOR, LOS ANGELES, CA, 90071, US

(73) Assignee: National Pen Corp., San Diego, CA (US)

(21) Appl. No.: 11/523,471

(22) Filed: Sep. 18, 2006

Related U.S. Application Data
(62) Division of application No. 11/186,172, filed on Jul. 21, 2005.

(51) Int. Cl. B41F 35/00

(52) U.S. Cl. 101/424.1

(57) ABSTRACT

A dual heating system and apparatus for high-speed printing is disclosed. A first heater that is a metal roller used in a printing machine. The outer surface of the metal roller may be covered by a silicone rubber coating material to enhance print transfer. This first heater is disposed adjacent to the second side of a print medium. A second heater, located adjacent to the outside of the silicone rubber coating of the first heater, allows supplementary heat to be added to the first heater such that improved printing speeds of heat transfer mechanisms may be achieved.

### CROSS-REFERENCE WITH RELATED APPLICATIONS

This application is a Divisional of application Ser. No. 11/186,172, filed Jul. 21, 2006, which is incorporated herein by reference.

### BACKGROUND

1. Field of the Invention

Embodiments described herein are directed to a dual heating system for generally any process where images are being heat transferred, such as processes involving decorative hot stamping foils, holographic foils, PMS color foils, silicon die impressed foils, and the like. More particularly, the embodiments are directed to a dual heating system for high speed printing of images, especially printed color images, on objects having a variety of sizes and shapes, by way of a hot stamping machine and/or a related hot stamping process or heat transfer mechanism.

2. Description of Related Art

Hot stamping machines, such as for example a Harvey roll-on deco machine, preferably a single head model HFR-100 or a double head model HFRO-200, typically contain a single heating element per head. Machines of this type are disclosed in U.S. Pat. No. 4,502,381. These machines were marketed by the Harvey Machine Co. of Nashville, Tenn. Another exemplary hot stamper is the PRECO™ automatic film transfer roll stamper machine, model KS-65. This machine was manufactured by the Preco Company of Osaka, Japan and also possesses a single heater.

The printing systems described above involve the transfer of predetermined images to objects. A commonly used system involves metal roller(s) that facilitates the transfer of images from a film to objects. The roller(s) impress the film over the surface of the object to transfer the image. Because objects that are impressed may have rounded surfaces, small imperfections that may appear in metal roller(s) do not provide a uniform image transfer. One method used to avoid this problem involves covering the metal roller(s) with a more flexible material such as silicone rubber. The flexibility of the silicone rubber coating or covering helps provide more continuous contact with the object surface and thus encourages a more uniform transfer. To further permit the transfer of the foil image, color or holographic foil on the object, heat and pressure must be applied from the roller against the film onto the object.

In such commonly used printing systems, the heating element is a part of the metal roller(s) of the respective hot stamping machine. As the number of printing transfers continue, a portion of heat is lost from the system. Therefore, the temperature of the heating element is often increased to maintain the outer surface of the rubber at a specific temperature, in order to compensate for the heat loss. However, if too much heat is generated from the heating element, adhesive between the metal roller(s) and the silicone rubber coating may separate and degrade, thereby leading to increased chances of delamination of the silicone rubber coating from the metal roller(s). As such, printing speeds are compromised because, for any number of reasons, the roller(s) cannot be readily heated beyond a certain temperature to compensate for the heat loss from the image transfer process. Consequently, although the printing system achieves its intended purpose, the speed at which printing transfers may be performed is limited by these temperature considerations.

Thus, there is a need for a manner by which to increase the printing speed without compromising the bond between the silicone rubber coating and metal roller(s).

### BRIEF SUMMARY

Embodiments of the present invention provide a way in which the temperature of roller(s) in printing systems are maintained to facilitate proper image transfer, even at increased speeds. In accordance with the present invention, heat loss from image transfers in the printing system may be compensated by directly applying a secondary source of heat directly to the surface of the silicone rubber coating or covering on the outer surface of the first heater.

In one embodiment, direct application of heat to the silicone rubber coating of the first heater may be immediately preceding the image transfer to the object. In this manner, the additional heat retained in the silicone rubber coating comes in contact with, and is transferred to, the object in the subsequent image transfer. The bond between the metal roller(s) and the silicone rubber coating is left substantially undisturbed because the secondary heat source maintains the temperature so that the first heat source does not need to be substantially increased.

The additional heat provided to the first heater, through this secondary source, thereby allows for a higher number of impressions to be made per unit of time without substantial risks of delamination in the system.

### BRIEF DESCRIPTION OF THE DRAWINGS

A detailed description of embodiments of the invention will be made with reference to the accompanying drawings.

FIG. 1 is a pictorial, side-elevational detail view of a portion of the interior of an embodiment of a stamper employed as a component of a system according to the invention;

FIG. 2 is a cross-sectional front view of an embodiment of the dual heaters employed as a component of a system according to the invention.

FIG. 3 is cross-sectional side view of FIG. 2.

FIG. 4 is a simplified pictorial view of one utilization of an embodiment of the system in accordance with the present invention; and

FIG. 5 is a cross-sectional view of a portion of a print medium that may be utilized in the practice of an embodiment of the system in accordance with the present invention.

### DETAILED DESCRIPTION

The present invention discloses a dual heating system and apparatus for hot-stamping machines or similar heat transfer mechanisms to achieve high-speed printing of images, such as for example printed color images, on objects having a variety of sizes and shapes, by way of a hot stamping machine and/or a related hot stamping process. The hot stamping machine may be a commercially available machine, for example a machine that is disclosed in U.S. Pat. Nos. 6,151,130 and 6,578,476, which are incorporated by reference herein.

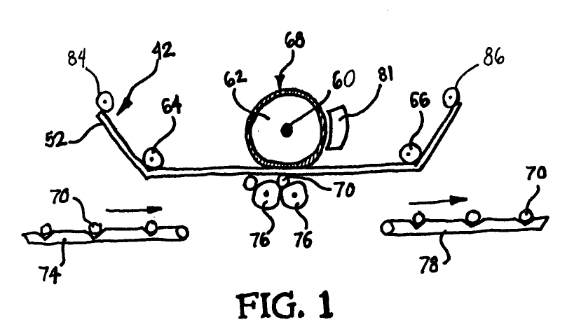

FIG. 1 shows the basic components of one embodiment of the present invention, respective to the components of a hot stamping machine as described in U.S. Pat. Nos. 6,151,130 and 6,578,476. The interior of the hot stamping machine depicted in FIG. 1 includes a heater 60 that is a metal roller 62, for example, a steel roller. The outer surface of the metal roller 62 has a silicone rubber coating or covering 68. To further explain the embodiments of the dual heating system for high speed printing, the following example for printing images on objects is provided. A substrate, such as a selected web strip 42, is fed through the machine and is guided around two guide rollers 64 and 66 so that the side with the coating 52 comes into contact with an object 70 that is to be decorated. The web strip 42 is oriented so that coating 52 faces downward. In one embodiment, the selected web strip 42 is a Mylar® film where the coating 52 includes selected images to be transferred to the peripheral surface of object 70. A succession of objects 70 upon which images are to be transferred is moved by a transporter. Such a transporter may form a type of assembly line where a number of steps may be performed in seriatim. For example, the transporter selected may be a conveyor. The conveyor 74 may take the form of a toothed conveyor, a walking beam, a conveyor belt, a rotary table, or any conveying means as is known in the art.

Each object 70 is conveyed, in turn, by the conveyor 74 to a transfer position where it is supported by a positioning mechanism that positions the object 70 such that the exterior surface of the object contacts the print medium. The positioning mechanism holds the object 70 so that the contact point on the print medium is a portion on which an image to be transferred has been printed. In one embodiment, as shown in FIG. 1, the positioning mechanism includes two pressure rollers 76 that position and support the object 70 so that it is impressed with the coating 52 of the web strip 42. As illustrated, each object 70 has the form of a generally circular shape. Other shapes are also within the scope of the embodiments of the present invention.

During the printing process, the strip 42 may be advanced along by another transporter. In FIG. 1, the transporter includes take-up roller 86, which unwinds the strip from roller 84 and advances the strip 42 at the proper speed for both imprinting the object and registering the strip 42 for the next object. The transporter further includes guide rollers 64 and 66 that move the strip 42 forward and provides a guided path for the strip 42 to advance along. The guide rollers 64 and 66 keep the strip 42 positioned properly in line with the object. Then, with the strip 42 adjacent to the metal roller 62, relative movement facilitates impression of each object 70 held by the rollers 76. As described above, the rollers 76 press the object 70 against the coating 52 on the strip 42. The object 70 may be displaced parallel to the coating 52 while rollers 76 are allowed to rotate freely about their respective axes so that object 70 rolls about its longitudinal axis along a selected length of coating 52 until the complete circumference of object 70 has made contact with strip 42. In this alternative, the movement may be so that the strip 42 is advanced forward while the object 70 is rotated in a fixed position by the metal roller 62 along the advancing strip 42 while being in contact with the coating 52 as it advances. As with the object 70, the metal roller 62 rotates in a fixed position while the strip 42 advances. In the above embodiments, the object 70 and coating 52 are maintained in non-sliding contact with one another while heat is applied by heater 60 and pressure is applied by rollers 76 in order to transfer a selected image to the peripheral surface of object 70. The image transfer may be facilitated through relative rotational movement between the object 70 and the metal roller 62. Due to its flexibility, the silicone rubber coating 68 maintains substantially continuous contact between the circumference of the object 70 and the coating 52 on the web strip 42.

The speed at which a printing system may operate depends on various factors, such as the size of the metal roller or the type of images to be transferred. In one preferred embodiment, a second, external heater 81 is located adjacent to the first heater 60. The external heater 81 allows supplementary heat to be added to the surface of the silicone rubber coating 68 of the first heater 60 such that approximately thirty impressions or more per minute may be achieved. Without external heater 81, approximately eighteen impressions per minute may be achieved. In some embodiments, the lower speed may be due, in part, to the fact that the heating element is in the center of the metal roller 62. Higher temperatures cannot generally be used, as higher temperatures tend to destroy the bond between the metal roller 62 and the silicone rubber coating 68. Thus, without the external heater 81, the speed at which heat may be transmitted from the first heater is limited.

By adding heat with the external heater 81, however, additional heat may be applied without destroying the bond between the silicone rubber coating 68 and the metal roller 62 because the heat is applied directly to the surface of the silicone rubber coating 68. The heat is substantially dissipated during the printing process, before the heat is able to reach the level where the metal roller 62 bonds with the rubber silicone coating 68. In this manner the second, external heater 81 may increase productivity by maintaining and even increasing the temperature without disturbing the bond.

After the image transfer, the object 70 is withdrawn from the image transfer position and may be placed on an exit conveyor 78. This exit conveyor may be a toothed conveyor, a walking beam, a conveyor belt, a rotary table, or any conveying means as is known in the art.

The stamping machine is provided with suitable mechanisms for conveying each object 70 in turn from the conveyor 74 to the transfer position, where it is supported by rollers 76, and for subsequently conveying the object 70, to which an image has been transferred, onto an exit conveyor 78. Conveyance of each object 70 to the transfer location is synchronized with the indexing movements of the strip 42.

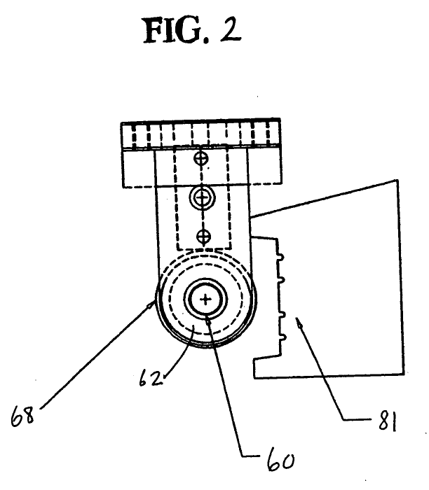

FIG. 2 illustrates a front view of an embodiment of the components of the dual heating system. The metal roller 62 is shown with the outer coating of silicone rubber 68 to help facilitate more uniform image transfer. The first heater 60 may be positioned inside the metal roller 62 or as part of the metal roller 62. The second, external heater 81 is shown adjacent to the first heater 60. The external heater 81 provides the supplementary heat needed to the surface of the silicone rubber coating 68 so that more impressions can be made per unit of time.

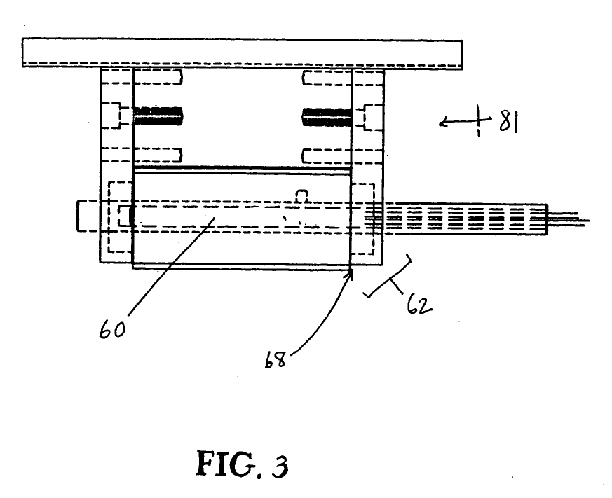

FIG. 3 shows a cross-sectional side view of FIG. 2. In the embodiment, the first heater 60 can be seen positioned within the metal roller 62 with the silicone rubber coating 68. The external heater 81 (not shown) is located on the other side of the system. In one embodiment, the first heater 60 and the second, external heater 81 may have a temperature range of from about 380 degrees Fahrenheit to about 400 degrees Fahrenheit.

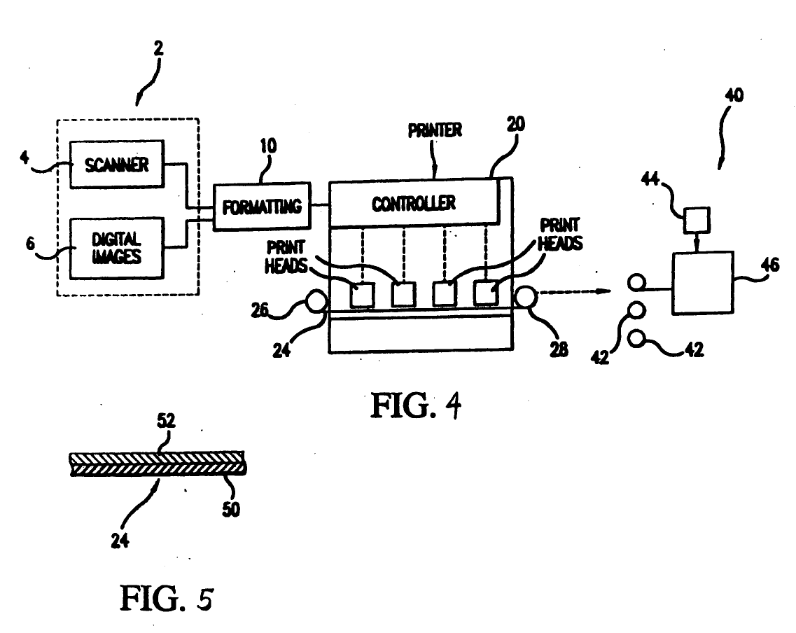

FIG. 4 illustrates a system with an assembly line process, where a number of steps may be performed serially, that may be used with another embodiment of the present invention. The illustrated system includes a digital data generating station 2 where digital data representing selected images are generated. By way of example, the digital data generating station 2 may include a scanner 4 and a memory 6 containing digital image data derived from any external source. The station 2 can consist of other sources of digital image data including a computer terminal connected to receive such data from remote locations including, but not limited to, Internet sites. Additionally, the system may also be used with other embodiments.

All of the data for images to be printed are supplied to a formatting station 10 that performs a variety of tasks. Specifically, in the formatting station 10, each image is formatted to the desired size. In addition, data representing each image is associated with position data designating the location at which the image is to be printed, either on a print medium or directly on an object. Depending on image size, a number of images can be placed side-by-side on the printing medium, to form several parallel columns of images, as well as being distributed along the length of the medium.

After data representing a plurality of images has been formatted and associated with position data, the combined data can be then transferred to the controller of a digitally controlled color printer 20, which is capable of performing full color printing on a print medium in the form of a long web.

The printer 20 includes four print heads, each for printing black or a respective primary color in order to produce full color prints. The printer 20 is further equipped to receive an elongated print medium web 24 initially supplied to the printer 20 in the form of a roll 26. The web 24 is unwound from the roll 26 and fed through the printer 20 by a pathway that passes each print head in succession.

The image data may initially be in any commonly used graphic format, a typical example being a Post Script™ format. The data processing system associated with the printer 20 may be of a type that utilizes bit map images and may be constructed to directly receive bit map images from any one of the image sources or to convert images in other formats, such as Post Script™ formats, into bit map image files. Suitable printers and accompanying software programs may be those disclosed in U.S. Pat. No. 6,578,476 as well as other printers known in the art.

After being printed, the web 24 may be wound into a take-up roll 28 and after the entire length of the web 24 has been printed, it can be delivered, for example manually, to an image transfer station 40. Depending on the needs and capacity of the transfer station 40, the take-up roll 28 may be cut lengthwise into a plurality of strips 42. Each strip 42 carries one column of images and may be formed into a roll for delivery to the transfer station 40. The transfer station 40 also includes a source 44 of objects to which the printed images can be transferred.

Alternatively, the web 24 may be fed from the printer 20 to the image transfer station 40 without first being wound into a take-up roll. In this embodiment, it is unlikely that the web 24 will need to be cut lengthwise into the plurality of strips 42. Ink jet heads like those available from APRION may be used for “in line” printing. Such ink jet heads are capable of shooting ink onto substrates such as paper and plastic. These differ from the XEIKON™ in that the XEIKON™ process uses electrostatic particles of toner. Other methods of applying ink are also within the scope of the embodiments of the invention.

As may be seen in FIG. 4, the image transfer station 40 may include, for example, a known high-speed hot stamping machine 46 which is equipped with a positioning mechanism to bring each object to which a printed image is to be transferred into position relative to an associated image on the web 24. Such mechanisms are known in the art. In this embodiment, after the object is positioned with the associated image, appropriate heat and pressure are applied to transfer the image to the object. Sufficient heat is supplied by a combination of a first heater located within the hot stamping machine 46 and a second heater located adjacent to the first heater. In one embodiment, the heat may be applied from the side of the print medium that is away from the object. The first and second heater may be arranged as disclosed in the above embodiments or as a flat heater as described in U.S. Pat. Nos. 6,151,130 and 6,578,476.

The methods according to the present invention may include coating an adhesive onto the object to be printed prior to transfer of the image from the substrate to the object. Such adhesives are well known in the art. The adhesive may serve to more firmly adhere the image to the object being printed, by being placed on the area that is to be covered by the image. The amount of adhesive placed may vary depending on need or convenience. The adhesive may also be placed such that it extends beyond the image. Alternatively, the adhesive may be selectively placed so that, when printed, the image entirely covers the adhesive. The adhesive may be placed on the object by any means as in known in the art including, but not limited to, dipping, spraying, and painting.

To perform the printing and image transfer operations that involve first printing on a web then transferring the images as described above, there is provided a substrate, that is a specially constructed web 24, which is capable of being wound into a roll and receive printed images in a manner that allows subsequent transfer of those images to the peripheral surfaces of objects. For this purpose, the web 24 may be composed, as shown in FIG. 5, of a suitable plastic substrate 50 provided with a special release coating 52 that is capable of retaining printing ink and of being easily separated from the substrate 50. By way of example, the substrate 50 may be made of Mylar® and the coating 52 may be a release coating that is formulated to retain a printed image until the coating 52 is applied against an object with sufficient heat and pressure to transfer the image to the object. This will ensure that images are not prematurely transferred from the coating 52 if the print medium 24 is wound into a roll 28 prior to transferring the image to the object.

As should be evident, the print medium 24 may be fed through the printer 20 with the release coating 52 facing the print heads and may further be fed through a pathway of the hot stamping machine 46 so that the coating 52 comes in contact with the object to which a printed image is to be transferred. One material which may be employed as a substrate 50 is a 75-gauge polyester film, obtainable from many sources.

The coating 52 may be based on an acrylic polymer modified with additives to enhance release from the polyester film 50 and aid in adherence to the target surface of the object. The additives employed may include melamine or urea-formaldehyde resins, microcrystalline waxes, acetylenic diols, plasticizers, solvents, or the like. The coating 52 may be produced from a material with a solvent-based formulation or an emulsion-based formulation. The former will generally be applied in the form of a continuous film, while the latter will take the form of a discontinuous film that is converted into a continuous film as a result of coalescense of the emulsion particles under heat and pressure during the stamping process. The following are exemplary formulations for each coating type.

| 1. Solvent Based: | |
|---|---|
| Acrylic Resin Solution in Mineral Spirits | 80.0% |
| Mineral Spirits | 12.0% |
| Microcrystalline wax | 8.0% |
| 2. Emulsion Based: | |
| Styrene acrylic emulsion | 55.0% |
| Ammonium Zirconium Carbonate Solution | 13.0% |
| Sodium Polyacrylate Solution | 4.0% |
| Polyoxyethylene Glycols | 0.5% |
| Microcrystalline wax | 10.0% |
| Deionized water | 9.5% |
| Isopropyl alcohol | 8.0% |

According to embodiments of the invention, the acrylic resin of the solvent-based composition is isobutyl methacrylate and/or butyl methacrylate polymer, and the styrene acrylic emulsion of the emulsion-based composition is an emulsion copolymer of styrene and 2-ethyl hexyl acrylate and/or butyl acrylate. The above formulas are given only by way of example; other formulations known to be suitable for use as coatings may be used.

Also within the scope of this invention is the use of a coating that has antimicrobial qualities, including antibiotic, antifungal, antiviral, and similar qualities. Since pens and similar writing instruments are often used by many different people, there is the possibility that they could transfer microbes from person to person. One possible solution to this problem is to incorporate sufficient amounts of an anti-microbial agent into the pen body. A problem with such approach, however, is that large quantities of the agent may be necessary to be effective. In the present invention, since only the outer surface of a pen is typically handled, only the outer surface is treated, e.g. by the use of a coating that contains such an antimicrobial agent.

Also within the scope of this invention is the use of a coating that has uv-protective qualities. Such a coating may be used to prevent fading and degradation on products that are exposed to ultraviolet rays, such as, for example, signage.

Either type of coating may be suitably applied to a Mylar® or other polyester substrate by, for example, a continuous web flexographic process or by other known techniques. After application, the coating may be dried under time and temperature conditions suitable for the vehicles employed.

Image data may be obtained simultaneously from a plurality of image sources. Each source may be a scanner, a computer, or the like.

According to the embodiments of the invention that involve printing first on a web and then transferring the images from the web to the objects, data from a plurality of sources, such as scanner 4 and memory 6 in FIG. 4, is processed and formatted so that the data from each source produces images in a respective column on the web 24 with each column extending in the direction of the length of the web 24 and the plural columns being spaced apart in the direction of the width of the web 24. Such sources may include, but are not limited to, a computer, a scanner, and the world wide web.

While the above description refers to particular embodiments of the present invention, it will be understood to those of ordinary skill in the art that modifications may be made without departing from the spirit thereof. The accompanying claims are intended to cover any such modifications as would fall within the true scope and spirit of the present invention.

The presently disclosed embodiments are therefore to be considered in all respects as illustrative and not restrictive; the scope of the invention being indicated by the appended claims, rather than the foregoing description. All changes that come within the meaning and range of equivalency of the claims are therefore intended to be embraced therein.

1. A dual heating system for high-speed printing onto a print medium, comprising:
a print medium having a first side and a second side, the first side carrying a coating which is releasable from the print medium and is formulated to retain printing inks;
a printing machine having a first heater, the first heater supplying heat to a predetermined surface of the print medium;
a second heater, located adjacent to the first heater, the second heater for supplying heat to an external surface of the first heater;
a first transporter for moving the print medium;
a second transporter for moving an object to be printed; and
a positioning mechanism for selectively positioning the object to be printed against the first side of the print medium.

2. The dual heating system of claim 1, wherein the first heater is a generally cylindrical metal roller, the metal roller having a silicone rubber external covering.

3. The dual heating system of claim 2, wherein the second heater is shaped so as to generally parallel the curvature of the metal roller.

4. The dual heating system of claim 1, wherein the second heater supplies an effective amount of heat to the first heater so as to generally compensate for heat loss of the first heater such that a predetermined printing speed is maintained.

5. The dual heating system of claim 1, wherein the second transporter is a conveyor adapted to place the object to be printed at a desired location relative to the print medium.

6. The dual heating system of claim 1, wherein the positioning mechanism includes a pressure roller for positioning the object to be printed such that an exterior surface of the object contacts the first side of the print medium.
